(19) United States
(12) Patent Application Publication
(10) Pub. No.: US 2024/0371140 A1
(43) Pub. Date: Nov. 7, 2024

(54) METHOD AND DEVICE FOR RECORDING TRAINING DATA

(71) Applicant: Carl Zeiss Microscopy GmbH, Jena (DE)

(72) Inventors: Manuel AMTHOR, Jena (DE); Daniel HAASE, Zoellnitz (DE); Alexander FREYTAG, Erfurt (DE); Christian KUNGEL, Penzberg (DE)

(73) Assignee: Carl Zeiss Microscopy GmbH, Jena (DE)

(21) Appl. No.: 18/565,671

(22) PCT Filed: May 18, 2022
(86) PCT No.: PCT/EP2022/063463

§ 371 Date: Nov. 30, 2023

(30) Foreign Application Priority Data
Jun. 2, 2021 (DE) 10 2021 114 349.7

(51) Int. Cl. G06V 10/774; G06V 10/82; G06V 20/69

(52) U.S. Cl. CPC G06V 10/774; G06V 10/82; G06V 20/693

(57) ABSTRACT

In a method, a device and a computer program product for acquiring images for training data to train a statistical model by machine learning for image processing in microscopy, the training data is made up of pairs of input images and output images from image processing. The method includes acquiring at least one image, analyzing the at least one image according to predetermined criteria, determining acquisition parameters for the acquisition of output images on the basis of the analysis results, and acquiring output images on the basis of the determined acquisition parameters.

The invention relates to the acquisition of images for training data to train a statistical model by machine learning for image processing in microscopy.

The present invention can, in principle, be used for every type of image processing, i.e. editing and processing an input image into an output image through machine learning. Machine learning can be used versatilely for image processing. For example, an artificial neural network (ANN), also referred to simply as a neural network, can be used, which is a specific form of machine learning. A number of examples for such types of image processing are given in the following:

Denoising or noise reduction of images, where a neural network can generate a less noisy image from noisier images.

Super resolution, also known as high resolution or optimised resolution, where a neural network can increase the resolution of images. In particular, high computing effort can achieve a higher quality here. Such methods are used, inter alia, for medical purposes, photography of astronomical objects, forensic analysis of image data, living cell image generation, and many more.

Deconvolution, whereby the resolution of an image can also be increased by back-calculating the previously applied convolution. The term point spread function (PSF) describes the convolution of a source into an acquired signal. Deconvolution then tries to reverse the effects described by the PSF. A known PSF can be used for deconvolution. What is known as blind deconvolution also exists whereby no PSF need be known.

A further field of use is, for example, the artificial ageing or rejuvenation of depicted people, which is also sometimes achieved through generative adversarial networks (GAN). GANs are part of supervised learning and consist of two artificial neural networks in which one, the generator, modifies images (‘candidates’) and the other, the discriminator, then evaluates the candidates. Both incorporate the results in their learning, such that the candidates constantly get better in the sense of the goal to be achieved, whereby the generator tries to learn to produce images which the discriminator cannot distinguish from real images, whilst the discriminator tries to learn to distinguish the increasingly improving images from genuine, real images.

Compressed sensing, where a neural network can sense and reconstruct sparsely populated signals or information sources in image data. Since due to its redundancy the information can be compressed without significant information loss, this is efficiently used in the sampling of signals to significantly reduce the sampling rate compared to conventional methods.

In the context of microscopy, virtual staining refers to the generation of images of a target contrast (e.g. fluorescence) from respective images of a source contrast (e.g. bright field) through image analysis & processing. In particular, image-to-image methods based on deep learning, but also other machine learning models, are used here. Such machine learning models are initially trained with training data so that they can subsequently make good ‘inference’ predictions. These training data consist of images which serve as input material for the model, as well as annotations which denote the respective desired model outputs.

In the case of virtual staining, the input images are source contrast images (often bright field), and the annotations are corresponding target contrast images (often fluorescent contrasts, for example by introducing a DNA (deoxyribonucleic acid) marker such as DAPI (4′,6-diamidino-2-phenylindole)). Other currently used stains are Hoechst 33342, NucSpot, Spirochromse SPY, GFP (green fluorescent protein) and tdTomato.

Due to the large variety of samples that can be analysed with microscopes, it proves difficult to provide a generally applicable pre-trained model with which virtual staining can be generated. The model can therefore be trained with specific training data for each examination.

The examination can thereby also be a new type of examination (e.g. a new combination of cell type and marker). The use scenario can hereby be sample-specific or sample-type-specific. The artificial neural network (ANN) can, incidentally, also be trained with continuous learning. The model can be constantly subsequently trained by the user. This can be done, for instance, by acquiring new samples. If, for example, a user only ever uses one particular sample type such as DAPI samples, a statistical model can be further specifically trained on that basis.

That means that often the training data also have to be acquired on the respective sample to be analysed, which is detrimental to the sample quality. Furthermore, the acquisition of training data takes time, and the acquisition of high volumes of training data also entails great effort for saving the data. Not least, training machine learning models with unnecessarily large datasets generally takes significantly longer than with smaller datasets.

According to the prior art, pre-trained, ready-to-use virtual staining models are often provided. Such pre-trained models cannot, however, cover the whole sample range in the field. Moreover, anomalies in the data, which usually represent interesting research points, are not sufficiently depicted. All possible stains and cell components or sample types would also need to be covered. That is, however, only possible with specially trained models.

Solutions to this provided by the prior art are always that the model itself is trained for the specific data. Input and output images of image processing (i.e. source and target contrast for the virtual staining) are thereby acquired automatically. That, however, that can be detrimental to the samples because the entire image and/or each image in a time series is always acquired in both contrasts. In particular with virtual staining, that means that the samples have to be treated with a stain to be able to generate the acquisition in the target contrast. Alternatively, the output images are captured at regular or random intervals. Temporary morphological states and/or changes or extraordinary structures can, however, be missed here, which can then not be depicted well by the model.

Furthermore, the entire sample is usually treated to generate the output images for training, which also represents an unnecessarily increased strain on the sample.

This applies equally to all other previously described image processing methods, because the samples for the acquisition of training data, i.e. the necessary input and output images of image processing, usually have to be captured several times. The invention is therefore also applicable to other types of image processing or image optimisation.

The object of the present invention is to overcome these disadvantages in the prior art and to propose an improved or at least alternative image processing method in neural networks.

This object is solved by a device and a method according to the claims.

For a better understanding of the invention, it is explained in more detail with reference to the following figures.

These show in significantly simplified, schematic representation:

FIG. 1 a schematic image processing sequence by a machine learning model, using virtual staining as an example, and

FIGS. 2 to 5 various exemplary criteria as applied for the acquisition of output images.

It is worth noting here that the same elements have been given the same reference numerals or same element configurations in the embodiments described differently, yet the disclosures contained throughout the entire description can be applied analogously to the same elements with the same reference numerals or the same element configurations. The indications of position selected in the description, such as above, below, on the side etc. refer to the figure directly described and shown, and these indications of position can be applied in the same way to the new position should the position change.

### FIGURE DESCRIPTION

The objective of the invention is to make the acquisition of training data as simple as possible, and at the same time ensure that the acquired training dataset is as informative as possible. Acquisitions which cannot significantly contribute to training are also avoided, which on the one hand saves time and effort, and on the other hand also particularly reduces the strain on samples.

It is thereby ensured that the users, who often do not have any particular expertise in the field of machine learning and/or neural networks, have less burden in this regard and can concentrate on the overarching scientific task.

Moreover, it can be ensured that the quality and the scope of the data required for the machine learning model complies with any applicable standards.

The underlying idea of this invention is to perform the acquisition of training and test data for image processing in a dynamic sample-and context-dependent manner. In particular, for instance, the position and time at which data are to be acquired are determined, which can later be used for training or model evaluation. The sample is thereby exposed to less strain and the time needed for data acquisition reduced, amongst other things.

In this invention, a device and a method for acquiring images for training data to train a statistical model by machine learning for image processing in microscopy is described, with the description of virtual staining as an example thereof.

In the following, a method for acquiring images for training data according to the invention is described, where an artificial neural network (ANN) is used for the machine learning. The training data consist of pairs of input images and output images from image processing. Using the example of virtual staining, the model is trained using input images in the source contrast (e.g. bright field) and the correspondingly assigned output images (e.g. fluorescent contrast), in order to then virtually generate a corresponding output image, i.e. the target contrast image, on further images in the source contrast, and not first treat the sample with the stain and then have to acquire the output image.

The image processing here can be virtual staining, noise reduction, super resolution, deconvolution, compressed sensing, or another type of image optimisation or image transformation.

The method comprises the acquisition of at least one image, The at least one image, or the images, are then analysed according to predetermined criteria. Subsequently, acquisition parameters for acquiring further images which can be output images and/or input images are determined based on the analysis results. Finally, the output images are acquired on the basis of the determined acquisition parameters.

The image(s) to be analysed, which are generally acquired via a microscope, can thereby be input images or output images. Several images can be acquired, only input images, only output images, or a combination of the two. In particular, the output images can be images that have already been acquired by the method. The images can be overview images, i.e. images which cover a larger area than the input and output images, or the area of a sample which is represented on several input or output images. These overview images are then available in lower magnification and/or resolution than the input and/or output images, but can be used to determine where interesting regions are for training. The images can also be sparsely sampled input or output images which can, however, be used to determine where interesting regions are for training.

The acquired images are subsequently analysed according to predetermined criteria. The analysis serves to identify images or image areas for which further acquisitions should be made and provided as training data.

The criteria according to which the images are analysed can be image structures present in the images, for instance. Other example criteria are relevant morphological changes and/or relevant movements in a time series of images. Results of anomaly and/or novelty detection which sense anomalies or newly arising groupings in samples, or similar, can be a criterion.

Further criteria can be, for example, the selection of new, information-bearing image areas for the acquisition of corresponding target images, whereby this task in the machine learning context is also known as active learning (AL). Change detection and novelty detection are special cases of AL strategies for time series acquisitions. Further strategies are, for example, generative methods (such as density-based estimators) which can be used for novelty detection, exploitation methods which use the currently learnt method for virtual staining and select information-bearing image areas in relation to that model (based, for instance, on greatest prediction uncertainty, or with respect to the greatest expected information gain, or results of an information-gain estimation, i.e. performed by evaluating the virtual staining model's prediction inaccuracy).

FIGS. 2 and 4 hereby show constellations or cells which are already sufficiently present in the training data. No acquisition of the target contrast is needed here.

FIG. 3 shows an example of a decision that a further acquisition should be performed. The cells shown in the upper section show an as yet not observed cell morphology. This ought then to be acquired in the form of the output image, i.e. in the target contrast, to be able to train the model on it.

FIG. 5 shows a further example. On the one hand, the input image shows a significant temporal change in the bottom left corner, and on the other hand detects a cell constellation that has not occurred thus far. Output images are now to be acquired from both areas to be able to train the model on them. Potentially necessary additional input images for the training which naturally have to be available corresponding to all output images of the training data can be acquired additionally. Thus, if it is determined from an available input image that a certain area should be provided as an output image for training, the respective area can also be acquired as an input image.

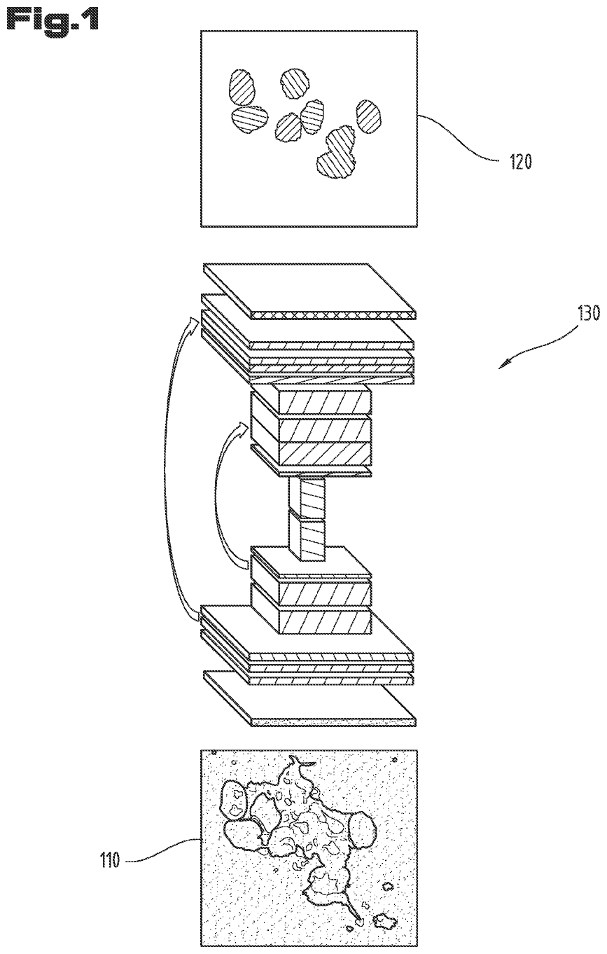

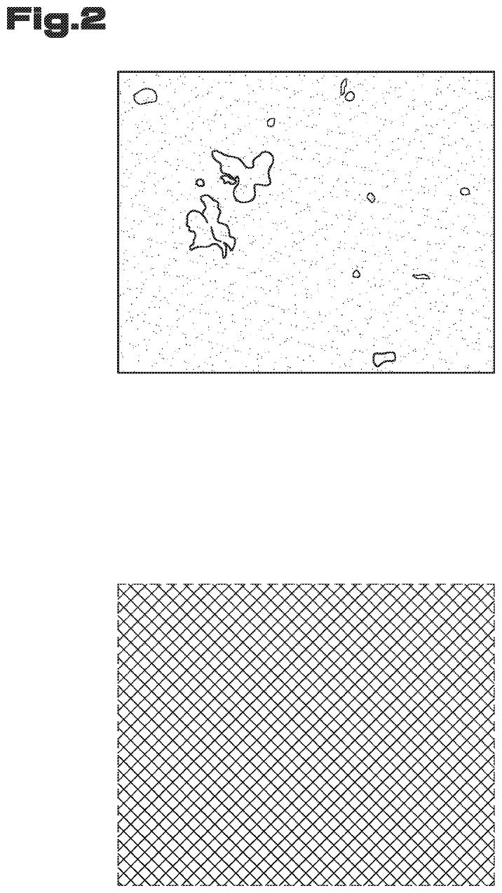

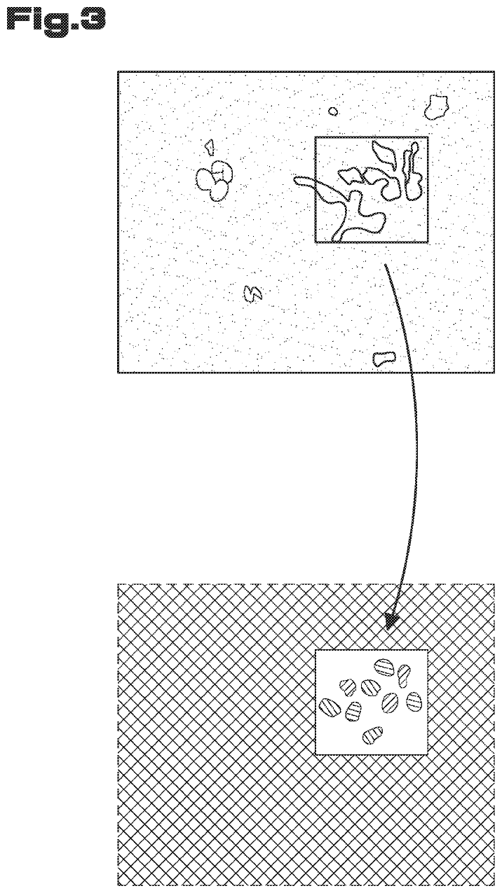

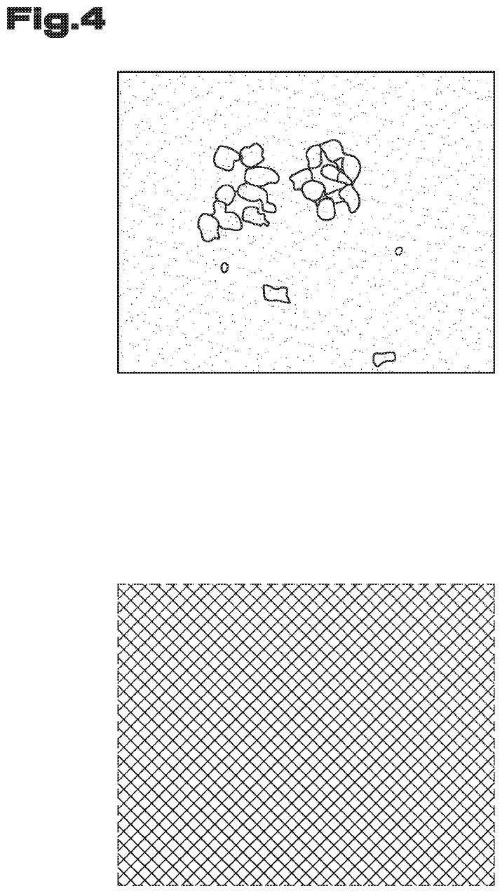

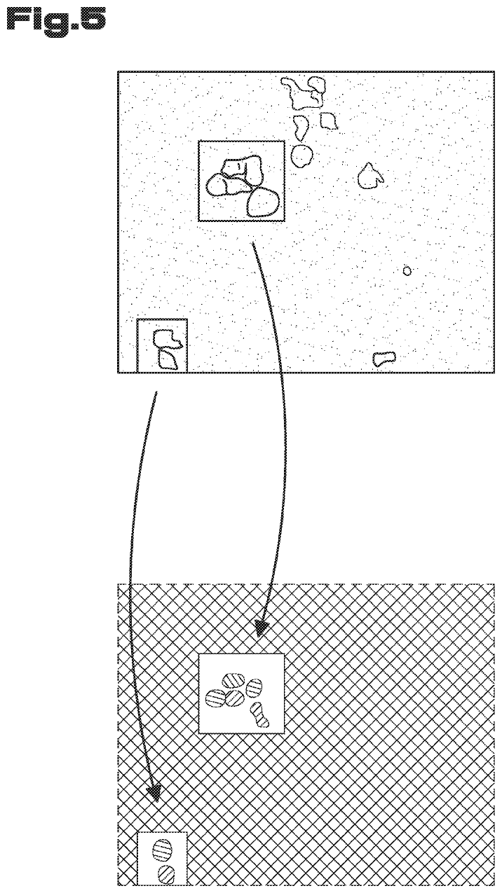

The criteria to be applied can be selected manually or be determined by the machine learning model. It is also conceivable to use a further machine learning model for this.

Acquisition parameters for the acquisition of output images are then determined on the basis of the analysis results. The acquisition parameters serve to determine the output images to be acquired, i.e. which samples, or which areas thereof, are to be acquired as an output image. For example, the acquisition parameters can comprise the indication of relevant images or image sections. The information as to in which depth plane (Z position) of a sample an acquisition is to be made can also be included. The acquisition parameters can also display one or more images of an image series (i.e. images of a sample which only differ in the time of acquisition) for acquisition. Furthermore, the acquisition parameters can indicate whether 2D or 3D images are to be acquired. Further acquisition parameters that can be determined concern the lighting intensity, the acquisition contrast, the acquisition method, and microscope settings such as lens, pinhole settings, and similar. Any combination of the above acquisition parameters can, of course, also be determined.

The acquisition parameters for a certain analysed image can of course also indicate that no further image need be acquired.

Examples of determinable acquisition contrasts are non-fluorescent contrast, fluorescent contrast, colour contrast, phase contrast, differential interference contrast, DIC, electron microscopy and x-ray microscopy.

Examples of determinable acquisition methods are bright field, wide field, dark field, phase contrast, polarisation, differential interference contrast and DIC methods, incident light microscopy, digital contrast, electron microscopy and x-ray microscopy.

Fundamentally, both image analysis and/or the determination of acquisition parameters for the acquisition of output images can additionally be influenced by context information, such as the type of task to be performed by the model to be trained and/or the type of image processing. Noise reduction models can, for instance, place a different focus when determining the acquisition parameters and during analysis of the images than super resolution models can, for instance. For example, other image areas and/or images can be selected for the acquisition of output images and other methods or contrasts can also be selected.

Input and output images can, incidentally, also be acquired by the same method and in the same contrast. The input and output images for super resolution, for instance, could thereby vary only in resolution but not in contrast or method. In other image processing methods, however, such as virtual staining, the resolution is usually the same, but the contrast and the acquisition method for the input images and the output images can vary.

The method can further comprise a determination of acquisition parameters for the acquisition of additional input images on the basis of the results of the analysis, and an acquisition of the additional input images on the basis of the determined acquisition parameters. If the images to be analysed are, for instance, overview images of input images, the method can select image areas of the overview images, and subsequently acquire new input images from these image areas. These new input images can then have a high resolution, for instance, or otherwise differ from the overview images. The same applies to the output images. Fundamentally, the same applies to the acquisition parameters for these input images as to the acquisition parameters for the output images as outlined above.

In specific terms, depending on the application, any combination of images to be analysed and images to be acquired is possible.

It is important that at the end of the method, an output image is present for each input image or image section that is to be used for training. Any missing input or output images can be acquired additionally. It is also possible to first determine for which images the respective other corresponding images are missing, and then issue a respective display.

That way, acquisition of time series or of a sequential acquisition of spatial samples (multi-view, z-stacks) can be performed. For such acquisitions of further images, minimum intervals between two acquisitions can also be determined (for example, a rule can be adhered to whereby two acquisitions should not occur within 10 minutes of each other, or that two acquisitions should not be made of directly adjacent regions). Alternatively, these conditions can be specified explicitly by the user. That has the advantage that the evaluation logic does not have to be triggered again for a while after a decided acquisition. That saves calculation and acquisition time.

The context information that can additionally influence the analysis of the images and/or the determination of the acquisition parameters for the acquisition of output images (and/or input images) can, for example, also be a desired level of protection of the samples depicted in the input and output images. It can thereby be shown how many samples are to be treated, potentially detrimentally, in order to be transferred from the state in which an input image is acquired into a state in which an output image is acquired.

It is also conceivable that additional acquisitions of input images can already damage the samples, such as how the potentially necessary lighting for a photographic acquisition can already be damaging to a sample. By using this context information, training data can be generated depending on a maximum permissible damage of samples, in order to thereby limit the amount of training data.

The type of sample, which indicates sensitivity to light, pressure, or similar environmental influences, can also influence the analysis of the images and the determination of the acquisition parameters.

Finally, further user information can influence the analysis of the images and the determination of the acquisition parameters, such as temporal parameters, personal preferences, etc.

Analysis and determination can also be performed by a further statistical machine learning model. One example of this is if it is known that too few mitoses are currently being acquired in the output images (for example on a new fluorescent channel). It is then possible to train a mitosis detector on the input images, for example, where the input images can be digital phase contrast (DPC) images, for instance. Such a mitosis detector can then be used to detect the presence of mitoses in the subsequently acquired DPC images and the acquisition of the target contrast can be triggered. In this example, it would thereby be possible to quickly generate a representative dataset with corresponding mitosis images for new target contrasts (e.g., new colourings). In the described scenario of such a mitosis detector, no additional subsequent training would even have to be performed for a further target contrast where the input image contrast is maintained.

This further statistical model can be pre-trained. The statistical model and/or the further statistical model can be configured respectively as a (artificial) neural network. The further statistical model can, for example, be configured such that it can be evaluated very quickly, indeed more quickly than usual change processes occur in the sample to be acquired. Alternatively, it can be assumed that the sample is substantially static, such as in the case of fixed cells, thus meaning that the acquisition of different contrasts at greater time intervals can be possible.

As previously described, it is important that at the end of the method, an output image 120 is present for each input image 110 or image section that is to be used for training. The corresponding input 110 and output images have to be assigned to one another, or at least be assignable to one another.

Acquisition parameters can also be determined by the method for the acquisition of additional input images.

Ultimately, the output images 120 are acquired on the basis of the determined acquisition parameters.

The method can further comprise the training of the image processing model using the input and output images acquired in this manner.

This training of the model can, however, only constitute an adjustment, i.e. subsequent training, of a pre-trained model.

By means of the method described here, an acquisition of training, validation and test data for the automatic training of an image processing model, such as virtual staining, is enabled in a manner which protects the samples. A dynamic sample-and context-dependent decision is thereby made about for which areas in an image and which images of a time series training, validation and test data of output images, such as in a target contrast, are acquired.

Decisions are hereby made about data acquisition aspects such as: relevant image areas (ranging from individual image points and regions of interest to whole images), z-position, time (of a time series), 2D or 3D acquisition, lighting intensity (noisy images perhaps suffice, although quality can also be of primary concern), and/or further acquisition parameters (microscope settings such as lens, pinhole settings, etc.).

A decision can thereby be made on the basis of information sources, such as overview image, source contrast image (usually wide field), last acquired target contrast image, sparsely sampled acquisition(s) of the source or target contrast, context information such as type of task/application (e.g. preview quality vs. publication quality), desired degree of sample protection, type of sample, user information.

For example, the following information from the aforementioned information sources can be used: structures in the image (overview, source or target contrast image), relevant morphological changes, relevant movements in time series, anomaly and/or novelty detection, i.e. as yet unseen cells/cell states etc. ought to be acquired urgently.

Various techniques can be used for analysis and determination, such as thresholding, e.g. for optical flow, localisation of relevant areas (or decision for entire image) by a machine learning model, supervised learning, e.g. detection & segmentation for image areas, classification for entire image, one class classification, anomaly and/or novelty detection, cluster analysis, reinforcement learning, (class-agnostic) saliency detection, and/or continuous and active learning.

It should be noted here that the calculation of the optical flow can be very difficult for such images in which the objects contained are very similar (such as images with a large number of very similar cells). In such cases, the estimation of the optical flow could very likely be unreliable. A better solution can then be to focus on the detection and tracking of these objects, such as the cells, and to determine the image acquisition parameters based on the tracking distance. Thus, the acquisition of a new fluorescent image can then only be triggered upon detection of a large tracking distance of the objects in the image. Furthermore, frequent experiments are very likely to always show significant changes between two time steps, such as seemingly moving objects, because living tissue always “moves”.

The following is an example use:

An acquisition of the time series in the source contrast is performed first. The degree of change between the images is then assessed by means of optical flow. Where there is sufficient change between certain image areas, the target contrast is then acquired there. That means that if nothing moves/changes, no additional images have to be acquired and the sample can be protected.

The following is a further example use: Firstly, sparsely sampled acquisitions of a target contrast image (e.g. fluorescence, such as after introducing markers like DAPI, GFP, etc.) are made. Cells are then localised in this sparsely sampled image. It is then determined which cells are suited/needed for a high resolution acquisition in the target contrast, such as because the chemical stain has not “leaked”. High resolution target contrast images are then acquired at the positions classified as high quality cells. Corresponding source contrast images are then subsequently acquired. Alternatively, an acquisition with a second fluorescent marker can be performed. In this case, the first fluorescent marker, such as a DAPI stain, can only be used for localisation.

A further example use is mitosis detection as described in detail above.

The example uses disclosed above serve solely to provide a better understanding. Further example embodiments can be formed from any combinations of the aforementioned aspects.

The use of one or more overview images as an information source is particularly useful. The use of context information as explained above is also useful. Furthermore, as opposed to training from scratch, existing pre-trained networks can be adjusted or optimised (continuous and active learning) using the method presented herein. This is particularly advantageous for scenarios in which statistical models should always be continuously trained for a new sample type/stain type/experiment type.

It is hereby reiterated that the present invention is not limited to virtual staining; rather, the presented method can equally be used for image-to-image methods (e.g. noise reduction, super resolution, deconvolution, compressed sensing, descattering, image optimisation, etc.).

The invention enables the acquisition of input images in a time series in an exclusively gentle contrast (bright field), and only if needed (i.e. if it is determined that the respective regions or images ought also to be present as output images in the training data) is the corresponding target contrast acquired. This way, a model can then be trained with which the complete time series can be displayed in the target contrast.

Furthermore, the invention allows for the optimisation of a model over a long period, i.e. over various experiments. It is hereby assumed that a user always observes more or less the same cells (or types of cells) and can thus continuously improve their model with each new sample.

In relation to the aspects outlined in this description as well as the information used accordingly, it is always possible to use an individual point or any combination thereof.

An example embodiment according to the invention is also a device for acquiring images for training data to train a statistical model by machine learning for image processing in microscopy. The training data consist of pairs of input images and output images of image processing and the device is configured to perform a method as described above. The device comprises an acquisition means which is configured to acquire images. The device can optionally further comprise a memory means which is configured to save data which comprise images. The device further comprises a processor means which is configured to analyse images according to predetermined criteria, and to determine acquisition parameters for the acquisition of output images on the basis of analysis results. The device further comprises an image generating means which is configured to acquire the output images on the basis of the determined acquisition parameters.

A further embodiment is a computer program product with a program for a data processing device, comprising software code sections for performing the steps according to the aforementioned method if the program is run on the data processing device.

This computer program product can comprise a computer-readable medium upon which the software code sections are saved, wherein the program can be loaded directly into an internal memory of the data processing device.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is defined by the claims. The description and the drawings should, however, be consulted when construing the claims.

Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

### LIST OF REFERENCE NUMERALS

110 Input image
120 Output image
130 Image processing by machine learning

1. A computer-implemented method for acquiring images for training data to train a statistical model (130) by machine learning for image processing in microscopy, wherein the training data comprise pairs of input images (110) and output images (120) from image processing, the method comprising acquiring at least one image,
analyzing the at least one image according to predetermined criteria,
determining acquisition parameters for acquiring output images (12) on the basis of analysis results, and
acquiring output images (120) on the basis of the determined acquisition parameters.

2. The method according to claim 1, wherein the image processing is virtual staining, noise reduction, super resolution, deconvolution, compressed sensing, or another type of image optimization.

3. The method according to claim 1, wherein the method further comprises the training of the model (130) for image processing.

4. The method according to claim 1, wherein the training of the model (130) is an adjustment of the model (130) for image processing.

5. The method according to claim 1, wherein the analysis and determination steps of the method are performed by a further statistical model of the machine learning.

6. The method according to claim 1, wherein the statistical model (13) and/or the further statistical model is a neural network.

7. The method according to claim 1, wherein the at least one image to be analyzed is one or more of the following:
an overview image, comprising one or more input (110) or output (120) images at lower magnification than the input (110) and/or output (120) images,
one or more of the input images (110),
one or more of the output images (120) which have already been acquired by means of the method, and/or
sparsely sampled input (110) or output (120) images,
and/or wherein the analysis of the images and/or the determination of acquisition parameters for the acquisition of output images (120) is additionally performed on the basis of context information, wherein the context information is one or more of the following:
type of task of the model (130) to be trained,
type of image processing,
desired protection level of samples depicted in the input (110) and output (120) images,
type of samples, and/or
user information.

8. The method according to claim 1, wherein the acquisition parameters are one or more of the following:
relevant images or image sections,
depth plane of samples,
relevant images of a series of images with different acquisition time,
acquisition type in 2D or 3D,
lighting intensity,
microscope settings such as lens, pinhole settings and similar,
acquisition contrast,
acquisition method, and/or
a combination of acquisition parameters.

9. The method according to claim 1, wherein the predetermined criteria are one or more of the following:
image structures,
relevant morphological changes,
relevant movements in a time series of images, and
results of a detection of anomalies and/or novelties.

10. The method according to claim 1, wherein the predetermined criteria are selected by the model (130).

11. The method according to claim 1, wherein the method further comprises a determination of acquisition parameters for the acquisition of additional input images (110) on the basis of the results of the analysis, and an acquisition of the additional input images (110) on the basis of the determined acquisition parameters.

12. The method according to claim 1, wherein one of the input images (110) and one of the output images (120) are assigned to one another and show the same,
wherein the input (110) and output (120) images differ in the acquisition method and/or acquisition contrast,
wherein the different acquisition contrasts are from the following group: non-fluorescent contrast, fluorescent contrast, color contrast, phase contrast, differential interference contrast, electron microscopy and x-ray microscopy and/or
wherein the acquisition methods are from the following group: bright field method, wide field method, dark field method, phase contrast method, polarization method, differential interference contrast method, incident light microscopy method, digital contrast method, electron microscopy method and x-ray microscopy method.

13. The method according to claim 1, wherein the method comprises the acquisition of further images, input images (110) and/or output images (120).

14. A device for acquiring images for training data to train a statistical model (130) by machine learning for image processing in microscopy, wherein the training data comprise pairs of input images (110) and output images (120) of image processing, wherein the device is configured to perform the method according to claim 1 and wherein the device comprises:
an acquisition means which is configured to acquire images,
a processor means which is configured to analyze images according to predetermined criteria, and to determine acquisition parameters for the acquisition of output images (120) on the basis of analysis results, and
an image generating means which is configured to acquire the output images (120) on the basis of the determined acquisition parameters.

15. A computer program product with a program for a data processing device, comprising software code sections for performing the steps according to claim 1 if the program is run on the data processing device.

16. The computer program product according to claim 15, wherein the computer program product comprises a computer-readable medium upon which the software code sections are saved, wherein the program can be loaded directly into an internal memory of the data processing device.
